(19) United States
(12) Patent Application Publication
(10) Pub. No.: US 2004/0237308 A1
(43) Pub. Date: Dec. 2, 2004

(54) Razor

(75) Inventors: Colin Mitchell, Auckland (NZ); Kurt Laurence Scholz, Auckland (NZ)

Correspondence Address: YOUNG & THOMPSON, 745 SOUTH 23RD STREET, 2ND FLOOR, ARLINGTON, VA, 22202, US

(73) Assignee: DER PATENTS LIMITED, AUCKLAND (NZ)

(21) Appl. No.: 10/855,639

(22) Filed: May 28, 2004

(30) Foreign Application Priority Data
May 29, 2003 (NZ) 526193

(51) Int. Cl. B26B 19/14

(52) U.S. Cl. 30/43.6; 30/43.4; 30/346.51

(57) ABSTRACT

Disposable razors are known. Unfortunately, “wet-shaving” is required with these razors which can be an inconvenience if the appropriate facilities are not readily available. Dry shaving would be ideal but dry shavers are not designed to be cheap enough to be disposable. The problem of providing a razor that could be used for wet or dry shaving that is cheap enough to throw away after a few uses is solved by the provision of a power operated razor 1 comprising a head 2 incorporating one or more cutter containing shaver heads 11, a body 3, a power supply 4 operatively connected to the or each cutter and an actuator 8 to actuate the razor 1, their arrangement being such that there is no normal means of access to the interior of the razor 1. This alleviates the problem because access to the working parts to replace them is denied.

### TECHNICAL FIELD OF THE INVENTION

The present invention relates to a razor, in particular, but not exclusively to a razor used in “dry-shaving”.

### BACKGROUND

Disposable razors formed from moulded plastics materials incorporating integral razor blades are well known. They are cheap to produce, easy to use and designed to be thrown away once they have become blunt as the razor blades cannot be changed.

They have become popular with many members of the public especially for temporary use, for example during a holiday break or in-between finding replacement razor blades for a users' preferred razor.

Their use on a temporary basis is usually because the quality of the razors produced in this manner is inferior to the more expensively produced “non-disposable” kind provided with replaceable self-contained razor blade units.

In addition to the quality issue, another problem that exists with this type of razor is that “wet-shaving” is required.

In other words, shaving foam or gel needs to be applied over the area to be shaved prior to the start of the shaving process.

This can be an inconvenience as the appropriate facilities to enable “wet-shaving” to take place may not be readily available.

Conventional electric razors, by their very nature are “disposable”. However, their expense tends to preclude them from being a mere “use and lose” item in the minds or potential purchasers.

### OBJECT

It is an object of the present invention to attempt to alleviate the problems as described herein-above and it will be appreciated that although the present invention may be embodied in several different aspects, these are nevertheless so linked as to form part of the same inventive concept.

### STATEMENTS OF THE INVENTION

According to the present invention in its broadest aspect there is provided A power operated razor comprising a head incorporating one or more cutter containing shaver heads, said head connected to a body, said razor being adapted to receive a power supply and said razor provided with an actuator to actuate the razor, the arrangement of said components being such that they are integral with the razor

Such an arrangement will allow the razor to be manufactured cheaply and will mean that the razor will possess a very limited life span and will thus become useless as a razor or shaving implement and will by necessity, become “disposable”. It is also intended that the razor could be stylised for use by men or by women and could even be waterproof through hermetic sealing.

The razor may be supplied with a power supply as part of the razor or a power supply may need to be introduced into the razor.

Preferably the razor is an integral unit, either with the power supply sealed in place in the factory or designed for one way insertion by a consumer/user so that the powers supply cannot be removed without breaking the razor.

In order to operate, the razor could be powered by a power supply adapted to produce an electrical form of energy. However, this need not be the only way in which a disposable razor of the present invention could be powered. Compressed gas operatively connected to a gas valve acting as an actuating switch could be used to drive a turbine that could either be linked directly to a cutter to cause a rotary cutting action or indirectly (via a cam) to produce a reciprocating cutting action.

The power supply could be a fuel cell.

More preferably, the razor has a pre-determined or otherwise pre-defined limited life.

It would be of tremendous advantage if the razor could be manufactured as an integral sealed unit in a factory where the power supply is of limited duration and completely sealed within the razor and whereby the only way of accessing the power supply would be to break the razor.

Preferably therefore, the power supply is permanently sealed within or is otherwise integral with the razor. For such an arrangement to be commercially effective, accidental drainage of the power supply prior to the sale of the razor would need to be prevented.

This could be achieved by employing a circuit breaker that would need to be fitted to the razor to ensure for example, that accidental actuation of the razor in the factory or in transit did not drain the power supply. Such a circuit breaker could be in the form of a pull tab, which when removed by a purchaser of the razor, would complete an electrical circuit within the razor enabling it to be used. The circuit breaker could also be in the form of a counter that counts down some aspect of use of the razor.

The head of the razor will comprise one or more shaver heads that may either be in the form of circular shaver head where the cutter stored within the shaver head will rotate to cause a cutting action. Alternatively, the or each shaver head may be in the form of a foil. If the razor is in the form of a foil, the cutter action will be a reciprocating action as opposed to a rotary action.

Preferably, the head incorporates one or more integral shaver heads, whereby access to the underside of the or each shaving head is not possible without breaking the razor.

As the razor is intended to have a deliberately limited life, the components that go into the manufacture of the razor will not need to be of a high quality, just functional, therefore the components are not likely to be expensive. On the contrary, far cheaper components than those normally associated with the manufacture of a razor could and will be used, thus rendering the finished razor as a very cheap item to buy. In this regard and in order to provide another or additional way of limiting the life of the razor, would be to incorporate a cheap cutter or a plurality of cheap cutter blades that would blunt relatively soon during use. Ideally, the or each cutter would have an intended useful life of no more than ten hours

Preferably, the or each shaver head incorporating one or more cutters, the or each cutter having a useful lifetime in the range of 1-7 hours of continuous usage of the razor.

The power supply to drive the motor is, by necessity operatively connected to the or each cutter.

In order to further ensure that the razor has a very limited life in addition to or instead of a power supply that can be renewed and/or blades that will blunt rapidly, it would also be preferable if the head incorporates a substantially non-emptiable shavings collector.

This arrangement would mean that the razor could not be used once the shavings collector was full as the shavings would either interfere with the movement of the or each cutter or any gearing or direct drive mechanism associated with the razor.

The power supply could be arranged to provide direct drive to the motor or indirect drive through a gearing mechanism. If there is more than one power supply, there could of course be more than one motor. This may be useful if direct drive to each motor from each respective battery is envisaged, alternatively, the cost of two small motors may be cheaper than one larger motor.

Preferably, the power supply to drive the motor is integral with, internal to and normally non-accessible from the exterior of the razor.

The power supply may be rechargeable, (though this is less preferable as it increases the cost and complexity and allows for an extended battery life beyond the desired limited life of the razor) and it may also be in the form of one or more batteries. If there is more than one battery, they could be disposed in side by side relationship or in an axial contiguous relationship within the razor. Various battery types could be used but for the sake of compactness of the finished product it is envisaged that only AA or AAA batteries or “coin-type” batteries are used.

The shavings collector maybe external to the razor, however, the shavings collector could also form an internal portion of the razor.

Preferably, the head of the razor incorporates an external viewing window integrally formed from plastics material as part of the head. This arrangement will provide a user of the razor with an indication of how full the shavings collector has become.

The body may also incorporate a frangible section to allow access to the or each power supply, if they are located here.

Preferably, the razor is provided with a frangible section.

More preferably, the frangible section is so located and designed as to cause the razor to break into separate and distinct head and body portions. This allows parts of the razor to be recycled or re-used by the manufacturer.

There are several ways in which the life of the power supply could be made limiting. Altering the size of the power supply of most products typically limits the useful life of the product if the power supply cannot be accessed for the purposes of replacement or repair. If one or more batteries are used as the power supply, then limiting the battery size and/or type would most likely be a way of providing the razor with a pre determined limited life.

However, preferably, the razor incorporates an electronic timer operatively connected to the power supply that is adapted to limit the duration of the power supply.

In this way, a definite time limit in respect of operation of the razor could be calculated and instituted. If the or each power supply were batteries, then only a proportion of the life of the or each battery could have been consumed.

Breaking the razor about the frangible section to generate separate head and body portions will no longer enable the razor to be used, but will allow access to the or each battery, then the or each battery could be used for other purposes eg powering a remote controller for a TV or CD/DVD system.

The actuating switch used to actuate the razor may be a slide action switch, moving from an “off” to an “on” position by sliding the switch from a first fixed position to a second fixed position, a flick switch or a touch pad. If a pull tab system to form a completed circuit is not used (vide supra), then other means of preventing accidental power drainage will need to be employed.

Preferably therefore, the razor further comprises a depressible actuating switch wherein the location of the switch in relation to the profile of the razor is such that the switch cannot be accidentally depressed if the razor is left in any orientation on a substantially flat support surface.

The actuation switch could also be operatively connected to a microchip or electronic counter which will allow the actuation switch to be switched on and off at least twenty times before breaking an electrical circuit within the razor thus preventing it from working again.

The profile of the razor may be substantially similar to the profile of a hand-held non-electric razor.

### BRIEF DESCRIPTION OF THE DRAWINGS

Preferred embodiments of the present invention will now be described by way of example only with reference to the accompanying drawings in which:

FIG. 1 illustrates a schematic view of a disposable electric razor according to one embodiment of the present invention.

FIG. 2 illustrates a perspective view of an alternative embodiment of the present invention.

FIG. 3 illustrates a schematic view of an alternative embodiment to that shown in FIG. 1.

FIG. 4 illustrates an embodiment that employs a “direct-drive”.

FIG. 5 illustrates a schematic series of views showing how a battery can only be inserted into the base end of the body portion of an embodiment of the razor in one direction only and once inserted, the illustrations show how the uni-directional means of battery insertion then acts as a means of battery capture and retention to prevent access to and removal of the battery.

FIGS. 6 & 7 illustrate another series of views that demonstrate how a battery may be inserted into another embodiment of the razor, again, in one direction only, but once inserted, the battery is biased in another direction to prevent access and thus removal from the razor once again.

FIG. 8 illustrates a razor incorporating a frangible section towards the head end of the razor which once actuated, destroys the razor but allows access to the batteries held within the razor.

FIG. 9 illustrates an embodiment that incorporates twin motors each adapted for direct drive of one of a respective pair of shaver heads.

FIG. 10 illustrates a gearing mechanism version of an embodiment employing a lithium coin cell.

FIG. 11 illustrates a schematic view of an embodiment that is not powered by a source of electrical power instead a means of generating a rotary cutting action for the razor through the use of compressed gas is illustrated.

FIG. 12 illustrates an alternative schematic view to that shown in FIG. 11, whereby a reciprocating cutting action using a cam and compressed gas is illustrated.

### DESCRIPTION OF THE PREFERRED EMBODIMENTS

Throughout this specification, the use of the word “integral” and variations of that word such as “integrally” is intended to cover not only something which is formed from the outset as one single-entity component, but also anything which, whilst being assembled from a plurality of initially disparately-produced integers, ends up as one overall and normally non-dismantle-able structure.

### EXAMPLE 1

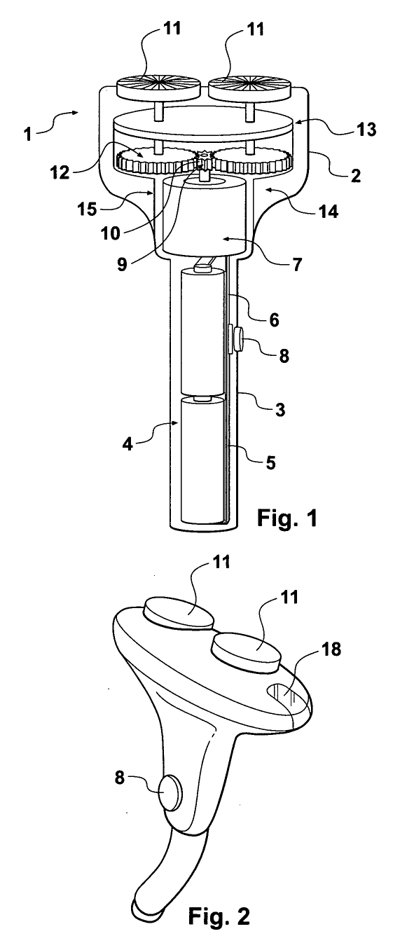

FIG. 1 shows a disposable electric razor generally referenced 1 that is designed for men. The razor 1, comprises a plastics head 2, integrally formed to one end of an elongate body 3 formed from a similar plastics material.

The dimensions of the body 3 are such that the longitudinal axis of two axially aligned “in-series” connected AA batteries 4, contained within the body 3, are each substantially coincident with the longitudinal axis of the body 3 and which also approximate to the height of the body 3. In series, these batteries 4 will typically produce 3V and a rating of 1200 mAh and as the razor 1 is intended to draw a maximum current of 100 mA in a worse case scenario, the lifetime of the batteries 4 will typically be about twelve hours (of continuous use).

The negative terminal of the lower battery 4, in the razor's in use position, contacts the base of an elongate substantially “L” shaped metal bar 5. The longest side of the bar 5, is spaced apart from the overlying batteries 4, and is discontinuous towards its upper end splitting the bar 5, into two portions 5, 6, a lower elongate portion 5, and an upper elongate portion 6. The upper elongate portion 6, continues along the same longitudinal axis as the lower elongate portion 5, an upper end of the upper portion 6, contacting one terminal of a motor 7. The positive terminal of the upper battery 4, contacts the remaining terminal of the motor 7.

The head 2 and the body 3 are heat-welded together locking the batteries 4 wholly within body of the razor 1 making access to the batteries 4 impossible without breaking the razor 1.

A depressible plastics switch 8, biased towards an “electrical circuit-incomplete” or “off” position by a spring (not illustrated) overlies the discontinuity between the upper 5 and lower 6 portions of the bar 5. The underside of the switch 8 is provided with a metal strip and it is this metal strip that overlies the discontinuity. The upper end of the motor 7 terminates in a gear wheel 9 provided with a plurality of peripheral cogs 10.

Two cylindrically shaped metal shaver heads 11, spaced apart in parallel side by side relationship project from the head 2, of the razor 1. The exposed substantially circular surface of each of the shaver heads 11 is reticulated to allow hairs to penetrate the shaver heads 11. A plurality of sharpened blades mounted on respective cylinders or cutters, each substantially concentric with each respective shaver head 11 and located just below the reticulated surface within the head 11 are adapted to rotate and cut hairs that pass through the reticulations.

The blades are each so surfaced finished that they will become blunt after a short period of time. This time period can be measured in only 1-2 hours of continued use. Access to the underside of the shaver heads 11 is impossible without breaking the razor 1 as the head 2 is not moveable or removable. The head 2 is also integral with the shaver heads 11. The cutters are each axially linked to respective centres of similar sized gear wheels 12. Each gear wheel 12, possesses a plurality of peripheral cogs. The cogs of each gear wheel 12 lie substantially in the same plane and engage with the cogs 10 of the gear wheel 9.

Located between the shaver heads 11 and the gear wheels 12, is an elliptical plate 13, the plate 13 being so dimensioned as to over-lie both of the gear wheels 12 to prevent shavings from falling on to the gear wheels 12 or between the cogs 10 and cogs of the gear wheels 12 thus interrupting the smooth engagement of each of the cogs.

Shavings are eventually collected in the pocket 14 which is defined by the internal space of the head 2 and a sleeve 15 that surrounds the motor 7, gear wheels 12 and periphery of plate 13.

When the switch 8 is depressed, the metal strip located at the lower part of the switch 8 contacts both the upper and lower 5, 6 portions of the bar 5 thus completing an electrical circuit and powering the motor 7 causing the cutters to rotate. As the shaver heads 11 contact the surface to be shaved, pre-shavings material enter the shaver heads 11 of the razor 1, through the reticulations, which are then cut by the rotating cutters and the shavings are collected in the pocket 14.

Once the pocket 14 is full, the shaver heads 11 become ineffectual as the shavings collect it the gaps between the cutters and the shaving heads 11. When this happens, the razor 1 has to be thrown away.

Alternatively, the blades of the cutter will become blunt before the pocket 14 fills and as a result the razor 1, still needs to be thrown away.

### EXAMPLE 2

FIG. 2 shows an alternative embodiment of the razor 1, whereby the shape of the razor 1 tends to mimic a conventional non-electric razor. In addition, the actuation button 8 is so located on the razor as to prevent accidental actuation of the razor if the razor is left on a flat surface (eg a table top) in any position. Furthermore, in this particular embodiment, the actuation button 8 is operatively connected to a microchip counter which will allow the actuation button 8 to be switched on and off twenty times before breaking an electrical circuit within the razor thus preventing it from working again. The razor incorporates an external viewing window 18 integrally formed from plastics material as part of the head 2. This arrangement will provide a user of the razor with an indication of how full the shavings collector has become.

### EXAMPLE 3

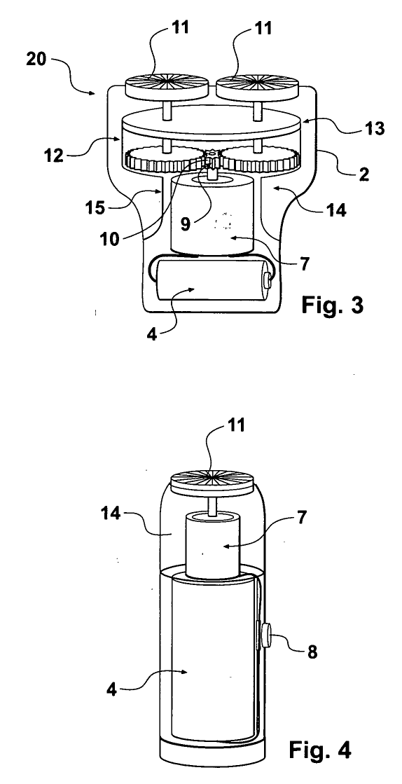

FIG. 3 shows an alternative embodiment of a more compact version of the razor shown in FIG. 1, generally referenced 20 that is designed for women. This particular embodiment is only powered by one AA battery 4, whose orientation is orthogonal to the direction of the batteries 4 shown in FIG. 1. Having a single battery 4 will halve the life of the razor 20 compared with the embodiment of FIG. 1. This embodiment is also provided with an electronic counter operatively connected to the switch 8 that will allow the switch to be operated twenty times before breaking the electrical circuit permanently thus rendering the razor unusable.

### EXAMPLE 4

FIG. 4 shows an embodiment employing “direct drive” instead of a gearing mechanism using cogs and gear wheels 9 & 12, as shown in FIGS. 1 & 3. In such an arrangement, the shaver head 11 is linked directly to the motor 7. This unit is intended to be factory sealed so that the user cannot access the shaver head 11 or the battery without breaking the razor casing. It is ideally suited for a AA battery and could be small enough and styled for the female user as a razor suited for shaving legs and/or arm pits.

### EXAMPLE 5

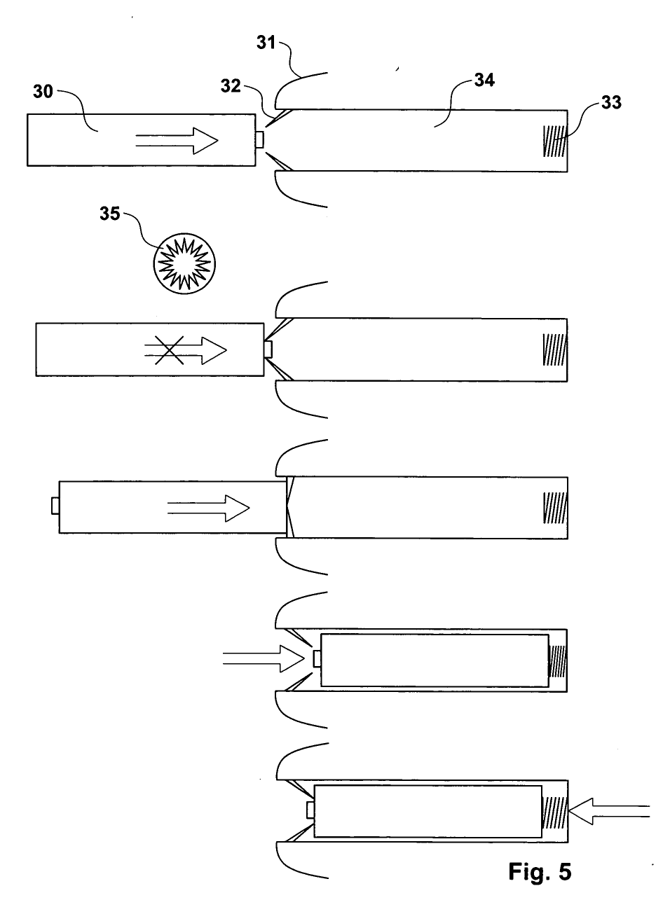

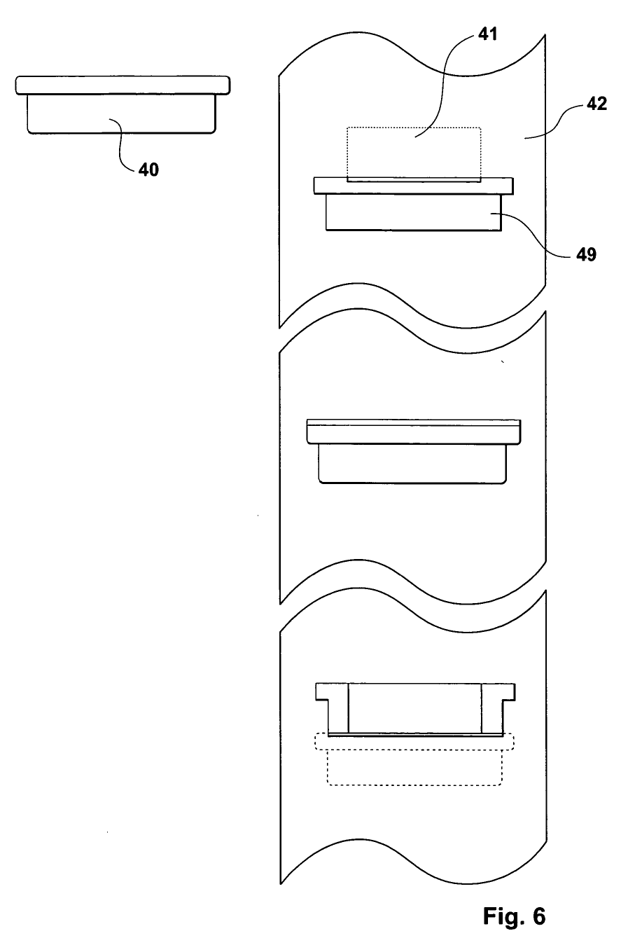

FIG. 5 shows a schematic series of illustrations of another embodiment of the present invention and how a cylindrical AAA battery 30 can be inserted into a complementary cylindrical battery receiving cavity 34 within a body 31 of a razor. In this particular embodiment, a circumferential internal saw-toothed washer 35 located towards the mouth of the battery receiving cavity 34, acts as a means to only allow battery insertion in one direction only into the cavity 34.

Each tang 32 of the washer 35 is initially angled towards the mouth entrance of the cavity 34 and the inner substantially circular concentric cavity generated by each projecting tang end is designed to be substantially identical to the circumference of the projecting “positive” terminal of the battery 30.

Thus any attempt to insert the battery 30 into the cavity 34 “positive end first” will allowing the positive terminal to pass through this circular concentric cavity generated by each projecting tang end 32 but, further attempted insertion of the battery 30 beyond this will now be prevented by the tang ends 32 being unable to move as they will each abut the circumferential wall of the positive terminal of the battery 30.

However, insertion of the battery 30 “negative end first” will allow the tangs 32 to move or otherwise freely rotate about the line of circumference of the cavity 34, as there is nothing for the tang ends 32 to abut during battery 30 insertion in this configuration, (the negative end of the battery 30 being substantially flat).

Therefore, continued finger insertion of the battery 30 “negative end first” into the cavity 34 is free to continue throughout the length of the battery 30. Eventually, the negative terminal of the battery 30 contacts a concentric biased metal contact 33, located at the base of the cavity 34, which compresses until the battery 30 is fully inserted into the cavity 34.

At this point, the battery 30 is released by the person inserting the battery 30, the tangs 32 are now being angled away from the mouth and the biased contact 33 is now able to push the battery 30 back towards the mouth of the cavity 34.

However, ejection of the battery 30 is not possible because once the positive terminal passes through this circular concentric cavity generated by each projecting tang end 32 once again, any further movement of the battery 30 is prevented as free movement of the tangs 32 is no longer possible as the tang ends 32 once again abut the circumferential wall of the positive terminal of the battery 30.

The washer 31 also serves as the other “contact” end for the battery 30 thus forming an electrical circuit once the razor is switched on. In this arrangement, the contact 33 maintains the battery 30 in its new, inserted state biased against the washer 35.

### EXAMPLE 6

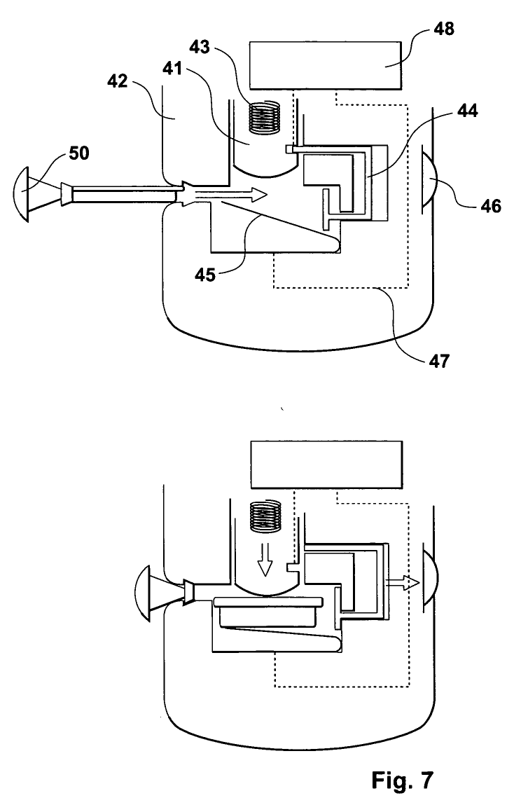

Turning now to FIGS. 6 & 7, these show front exterior and side interior views of another embodiment showing another way of inserting a battery 40 into a razor that would prevent its removal except by tampering with the razor to an extent that it would probably not be useable thereafter.

This particular embodiment, uses a relatively flat circular lithium cell or “coin cell” battery 40 having a wider concentric top relative to its base. This battery 40 is a typical 3V battery, with a typical 700 mAh rating and as such is intended to provide approximately 7 hours of continuous use.

The shape of the battery 40 is important as the side profile of the battery 40 is such that a complementary aperture 49 in the body of the razor 42, will only allow battery 40 insertion in one direction only, the correct one.

In this particular embodiment, within the body 42 and set above the top of the mouth of the aperture 49, is a tubular electrical contact 41 biased by a mechanical spring 43. The tubular contact 41 is so sized and shaped as to span the aperture 49 and the contact 41 is adapted to travel in a direction substantially orthogonal to the direction of battery 40 insertion. However, it is prevented from travelling anywhere by one end of an elongate stop member 44 that sits within a cavity of the tubular contact 41.

The member 44 is itself prevented from moving in a similar direction because a portion of it sits on a shelf within the body 42. Nevertheless, the member 44 is adapted to slide along the shelf in the same direction as the battery 40 as it is inserted into the body 42 of the razor.

The elongate stop member 44 is provided with two folds through 90 degrees in the same direction and in the same plane and terminates in a flat plate that is orthogonal to and projects beyond the width of the other end of the elongate member 44. The plate lies beyond the contact 41 and is parallel with and opposite to the entrance of the aperture 49

The contact 41 is itself opposite another biased contact 45 set at a point below the base of the mouth of aperture 49 and at substantially the height of the battery 40. Both contacts 41;45 are operatively linked by wire 47 to the motor 48, that will be used to rotate the or each cutter of the razor (not illustrated), the wire 47 is also provided with a circuit break in the form of a depressible switch 46 mounted to the exterior of the body 42.

Any attempt to insert the battery 40 into the aperture 49 in other than the correct orientation will not work because of the size and shape of the battery 40 and aperture 49. Insertion of the battery 40 through the aperture 49 in the correct orientation either by pushing with a finger, directly against the battery 40 or, as illustrated, by using a battery insertion plug 50, will eventually mean that the initially inserted end of the battery 40 will contact the plate.

As the battery 40 enters the body of the razor 42, the inserted end of the battery 40 contacts the plate after approximately two thirds of the battery 40 has been inserted and continued insertion of the battery 40 after this point, causes the member 44 to slide along the shelf in the same direction as the direction of travel of the battery 40.

Once the battery 40 has been completely inserted into the body 42 of the razor, the end of the member 44 leaves the cavity of the contact 41, allowing the spring 43 to drive the contact 41 down and into contact with the top of the battery 40. This biasing force of the spring 43 further drives the top of the battery 40 below of the base of the mouth of aperture 49 and into contact with the opposing contact 45.

Furthermore, the insertion plug 50 is provided with a resilient fitment that compresses as it passes a point of constriction in the body 42 of the razor but expands again to fill the space beyond the constriction thus locking the plug 50 into place and forming part of the razor.

In such an arrangement, in order to complete an electrical circuit, the switch 46 only needs to be depressed sufficiently to allow an electrical circuit to be created. Furthermore, access to the battery 40 once fully inserted is denied by the tubular body of the contact 41 acting as a door closing and permanently sealing the aperture 49.

As will be appreciated from the above two examples, battery deterioration will not occur prior to the battery 30;40 being inserted into the razor.

### EXAMPLE 7

In an alternative embodiment (not illustrated), the shaver could be supplied with a number of batteries integral with the shaver and a pull tab, one end of which projects from an aperture in the body of the shaver. The other end would cover one terminal of the battery and act as an insulator or circuit breaker and hence isolate the battery 30;40 from a contact. Pulling on the tab will remove it from the shaver allowing the battery to come into contact with the contact and complete the necessary electrical circuit.

Such an arrangement will also provide a means of reducing battery deterioration to an absolute minimum.

### EXAMPLE 8

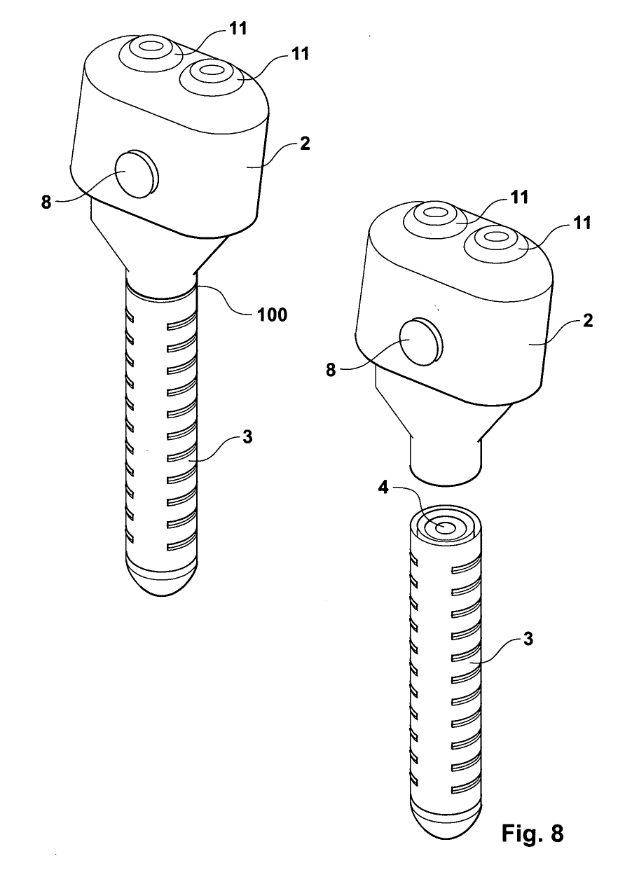

Turning now to FIG. 8, this shows an embodiment of the razor incorporating a frangible portion 100 at a proximal end of the body 3, adjacent the head 2 of the razor. In this particular embodiment, the AA batteries 4, initially integrally formed with the razor, are operatively connected to an electronic timer (not illustrated) that is adapted to limit the duration of the razor's operation. The two AA batteries 4 are limited to 4 hours use at 75 mAh by the timer and as such will typically have only consumed about 300 mAh of these batteries typical 1200 mAh.

Thus, in this particular embodiment, the batteries 4 will still be approximately 75% charged and thus, breaking the razor in two at the frangible portion 100, will allow access to the batteries 4 which whilst destroying the razor will enable these batteries 4 to now be used to power a number of other items including for example a TV remote control unit.

### EXAMPLE 9

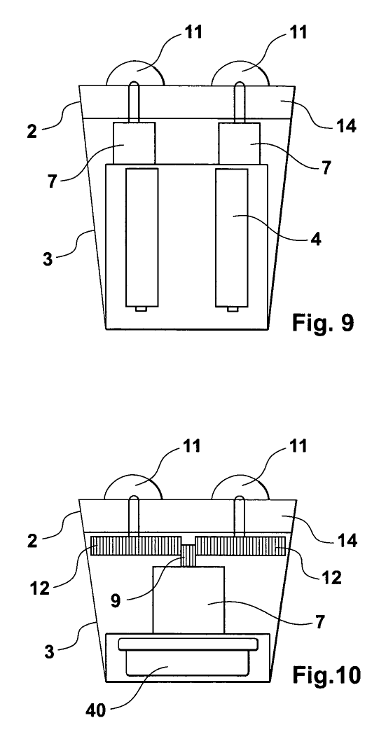

Turning now to FIG. 9, this shows an embodiment that incorporates a pair of motors 7. Each motor 7 powers a shaver head 11 via direct drive and the embodiment is powered by a pair of batteries 4 set in side by side relationship.

### EXAMPLE 10

Turning now to FIG. 10, this embodiment shows a gearing mechanism version that employs a lithium coin cell.

### EXAMPLE 11

In a non illustrated embodiment the shaver head 11 may be in the form of a foil. If the razor is in the form of a foil, the cutter action will be a reciprocating action as opposed to a rotary action. Furthermore, the time period before the cutters become blunt, may be in the range of 1-420 minutes, more particularly, this time period can be 1-60 minutes.

### EXAMPLE 12

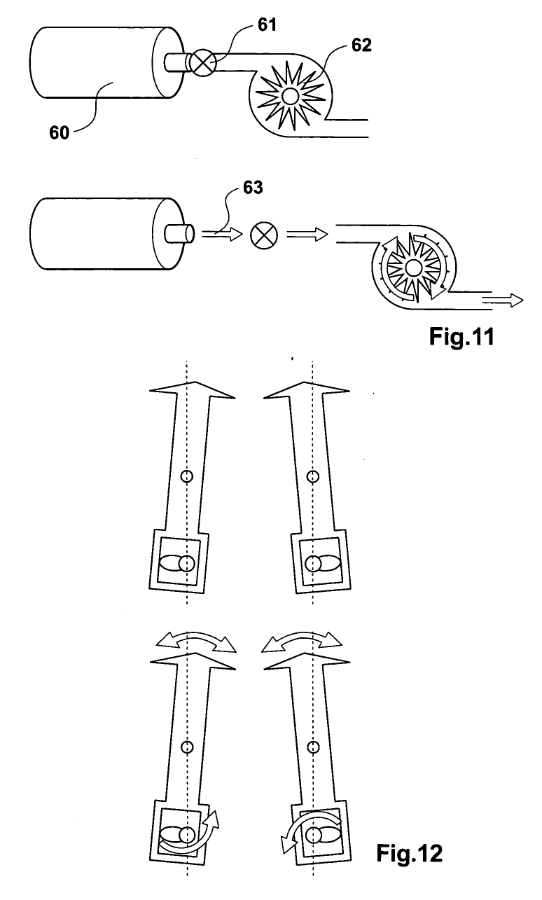

Turning now to FIG. 11, this shows a very schematic view of one embodiment of the present invention that does not involve electrical power to power the shaver. Instead, the razor would incorporate an integral miniature compressed gas cylinder 60 is operatively connected in series with a gas valve 61 and a turbine 62. The valve 61 and turbine 62 are substantially sealed within a passageway that has an exit port to allow the escape of gas. Upon actuation of the gas valve 61, compressed gas enters the passageway in the direction of the arrows 63 causing the turbine 62 to rotate at high speed, the spent gasses subsequently passing out through the exit port. Axially linked to the turbine 62 will be a shaver head and cutter (not illustrated). As the turbine 62 rotates, the cutter will also rotate and work in the same manner as previously described herein. The cylinder 60 once it has run out of gas will not be able to operate the razor any ore and when this happens, the razor will need to be disposed of.

### EXAMPLE 13

Turning finally to FIG. 12, this crudely shows how the turbine 60 (not illustrated) could form part of a camming surface which if operatively connected to a reciprocating cutter, would allow shaving to occur whilst using a compressed gas cylinder of the type shown in FIG. 11 with a disposable foil razor.

The materials from which the razor can be constructed maybe selected without further inventive thought by the intended skilled addressee of this specification. Furthermore throughout the description and claims of this specification the word “comprise” and variations of that word, such as “comprises” and “comprising”, are not intended to exclude other additives, components, integers or steps.

This invention may also broadly be said to consist in the parts, elements and features referred to or indicated in the specification of the application, individually or collectively and any or all combinations of any two or more of the parts, elements or features and where specific integers are mentioned herein which have known equivalents, such equivalents are doomed to be incorporated herein as if individually set forth.

For the avoidance of doubt, the terms “razor”, “shaver” “electric shaver” or “electric razor” or generally accepted variants of any of the above are each intended to cover any device that could be used for shaving, be it in the form of conventional “wet” or “dry” shaving.

Advantages

Limited life—the razor is intended to have a deliberately limited life, the components that go into the manufacture of the razor will not need to be of a high quality, just functional, therefore the components are not likely to be expensive.

Sealed unit—if the razor is hermetically sealed, there is no reason as to why it cannot be used under water in a bath of shower or in the process of wet shaving as well as dry shaving.

We claim:

1. A power operated razor comprising a head incorporating one or more cutter containing shaver heads, said head connected to a body, said razor adapted to receive a power supply and said razor provided with an actuator to actuate said razor, wherein said razor is provided with means to give said razor a predetermined limited life.

2. A razor as claimed in claim 1, wherein said razor is an electric razor.

3. A razor as claimed in claim 1, wherein said means are provided by said head incorporating one or more integral shaver heads, whereby access to the underside of the/or each shaver head is not possible without breaking said razor.

4. A razor as claimed in claim 1, wherein said means are provided by the or each cutter having a useful lifetime in the range of 1-7 hours of continuous usage of said razor.

5. A razor as claimed in claim 1, wherein said means are provided by said head incorporating a substantially non-empty-able shavings collector.

6. A razor as claimed in claim 1, wherein said razor is fitted with a motor driven by said power supply, said motor being integral with, internal to and normally non-accessible from the exterior of said razor without breaking said razor.

7. A razor as claimed in claim 1, wherein said head of said razor incorporates an external viewing window, integrally formed from plastics material as part of said head.

8. A razor as claimed in claim 1, wherein said razor is provided with a frangible section.

9. A razor as claimed in claim 9, wherein said head is connected to said body via said frangible section.

10. A razor as claimed in claim 1, wherein, said means are provided by said razor incorporating an electronic timer operatively connectable to a power supply and wherein said timer is adapted to limit the duration of said power supply.

11. A razor as claimed in claim 1, wherein, said means are provided by said razor incorporating an electronic counter operatively connected to said actuator, said counter being adapted to limit the useful life of said razor.

12. A razor as claimed in claim 1, wherein the location of said actuator in relation to the profile of said razor is such that said actuator cannot be accidentally actuated if said razor is left in any orientation on a substantially flat support surface.

13. A power operated razor comprising a head incorporating one or more cutter containing shaver heads, said head connected to a body, said razor containing a power supply and said razor provided with an actuator to actuate said razor, the arrangement of said components being such that there is no normal means of access to the interior of said razor and wherein said razor is provided with means to give said razor a predetermined limited life.

14. A razor as claimed in claim 13, wherein said razor is an electric razor.

15. A razor as claimed in claim 13, wherein said means are provided by said head incorporating one or more integral shaver heads, whereby access to the underside of the/or each shaver head is not possible without breaking said razor.

16. A razor as claimed in claim 13, wherein the or each cutter has a useful lifetime in the range of 1-7 hours of continuous usage of said razor.

17. A razor as claimed in claim 13, wherein said means are provided by said head incorporating a substantially non-empty-able shavings collector.

18. A razor as claimed in claim 13, wherein said razor is fitted with a motor driven by said power supply, said power supply, said means are provided by said power supply being integral with, internal to and normally non-accessible from the exterior of said razor without breaking said razor.

19. A razor as claimed in claim 13, wherein the head of the razor incorporates an external viewing window, integrally formed from plastics material as part of said head.

20. A razor as claimed in claim 13, wherein said razor is provided with a frangible section.

21. A razor as claimed in claim 20, wherein said head is connected to said body via said frangible section.

22. A razor as claimed in claim 13, wherein, said means are provided by said razor incorporating an electronic timer operatively connected to said power supply, said timer being adapted to limit the duration of said power supply.

23. A razor as claimed in claim 13, wherein, said means are provided by said razor incorporating an electronic counter operatively connected to said actuator, said counter being adapted to limit the useful life of said razor.

24. A razor as claimed in claim 13, wherein the location of said actuator in relation to the profile of said razor being such that said actuator cannot be accidentally actuated if said razor is left in any orientation on a substantially flat support surface.
